(19) United States
(12) Patent Application Publication
(10) Pub. No.: US 2017/0219356 A1
(43) Pub. Date: Aug. 3, 2017

(54) WARNING NOTIFICATION SYSTEM, WARNING NOTIFICATION METHOD, AND COMPUTER READABLE MEDIUM

(71) Applicant: MITSUBISHI ELECTRIC CORPORATION, Tokyo (JP)

(72) Inventors: Shu MURAYAMA, Tokyo (JP); Junya UJIIE, Tokyo (JP)

(73) Assignee: MITSUBISHI ELECTRIC CORPORATION, Tokyo (JP)

(21) Appl. No.: 15/329,061

(22) PCT Filed: Aug. 6, 2014
(86) PCT No.: PCT/JP2014/070725

§ 371 Date: Jan. 25, 2017

(51) Int. Cl. G01C 21/26; G01C 21/36

(52) U.S. Cl. CPC G01C 21/26; G01C 21/3617; G01C 21/3691

(57) ABSTRACT

The present invention includes a route acquisition unit (210) that acquires moving route information indicating a moving route of a vehicle, an event acquisition unit (120) that acquires event information representing an event associated with the moving route, a situation acquisition unit (160) that acquires situation information representing a travelling situation of the vehicle, a notification-determination-condition information (180) representing whether or not to issue a warning with respect to a risk event in each case of a plurality of travelling situations, and a determination unit (170) that determines whether or not to issue the warning, based on the notification-determination-condition information (180) and the travelling situation acquired by the situation acquisition unit (160).

### TECHNICAL FIELD

The present invention relates to a warning notification system, a warning notification method, and a program. In particular, the present invention relates to a warning notification system, a warning notification method and a program that issue a warning relating to a risk event on a travelling route of a vehicle.

### BACKGROUND ART

In conventional driving support apparatuses, there is an apparatus that stores location information on a point where an accident occurred in the past; data of a driving type to which a driving inclination of a driver who caused the accident is classified; and data of a time period when the accident occurred, a travelling situation such as weather, and an accident type; to an accident table stored in a server (for example, refer to Patent Literature 1). This driving support apparatus executes processing to issue a warning to a driver of a vehicle as described below.

Firstly, this driving support apparatus decides location information, a driving type, and a travelling situation of the vehicle, based on information from a sensor mounted on the vehicle. Then, this driving support apparatus refers to the accident table and determines whether or not there is a risk point within a predetermined distance range, based on the decided location information, driving type and travelling situation. Then, when determining that there is the risk point within the predetermined distance range, this driving support apparatus notifies the driver of the vehicle of risk information relating to the risk point.

### CITATION LIST

### Patent Literature

Patent Literature 1: JP 2006-258428 A

### SUMMARY OF INVENTION

### Technical Problem

A conventional driving support apparatus associates an accident occurred in the past with location information, a driving type, and a travelling situation at the time of the occurrence of an accident, in an accident table. When the location information, the driving type, and the travelling situation at the time of the occurrence of the accident coincide with present location information, driving type, and travelling situation, the driving support apparatus issues risk information. Accordingly, a condition to issue the risk information cannot be changed flexibly, and there is a case where the risk information is not issued if the travelling situation of the vehicle and the situation at the time of the occurrence of the accident are even slightly different. Therefore, a problem arises that reliability of the conventional driving support apparatus is low.

The present invention is made to solve a problem such as above and aims to provide a highly reliable warning notification system, a warning notification method, and a program which are capable to issue a warning relating to risk information appropriately.

### Solution to Problem

A warning notification system according to the present invention includes:

a route acquisition unit to acquire moving route information indicating a moving route of a vehicle;

an event acquisition unit to acquire event information representing an event associated with the moving route;

a situation acquisition unit to acquire situation information representing a travelling situation of the vehicle;

a notification-determination-condition storage unit to store a condition for determining whether or not to issue a warning with respect to the event in each case of a plurality of travelling situations, as a notification-determination-condition; and

a determination unit to determine whether or not to issue the warning, based on the notification-determination-condition and the travelling situation acquired by the situation acquisition unit.

A waning notification method of a warning notification system according to the present invention includes:

by a route acquisition unit, acquiring moving route information indicating a moving route of a vehicle;

by an event acquisition unit, acquiring event information representing an event associated with the moving route;

by a situation acquisition unit, acquiring situation information representing a travelling situation of the vehicle; and

by a determination unit, determining whether or not to issue a warning, based on a notification-determination-condition for determining whether or not to issue the warning with respect to the event in each case of a plurality of travelling situations and the travelling situation acquired by the situation acquisition unit.

A program according to the present invention causes a computer to execute:

route acquisition processing to acquire moving route information indicating a moving route of a vehicle;

event acquisition processing to acquire event information representing an event associated with the moving route;

situation acquisition processing to acquire situation information representing a travelling situation of the vehicle; and

determination processing to determine whether or not to issue a warning, based on a notification-determination-condition for determining whether or not to issue the warning with respect to the event in each case of a plurality of travelling situations and the travelling situation acquired by the situation acquisition processing.

### Advantageous Effects of Invention

According to warning notification systems of present embodiments, a determination unit determines whether or not to issue a warning, based on a notification-determination-condition indicating whether or not to issue the warning with respect to an event in each case of a plurality of travelling situations and based on a travelling situation of a vehicle, so that there is an effect capable of appropriately issuing the warning.

### BRIEF DESCRIPTION OF DRAWINGS

FIG. 1 is a block configuration diagram illustrating an example of a block configuration of a warning notification system according to a first embodiment.

FIG. 2 is a diagram illustrating an example of a configuration of a vehicle information according to the first embodiment.

FIG. 3 is a diagram illustrating an example of a configuration of an environmental situation information according to the first embodiment.

FIG. 4 is a diagram illustrating an example of a configuration of a notification-determination-condition information according to the first embodiment.

FIG. 5 is a diagram illustrating an example of a hardware configuration of a server apparatus and an on-vehicle apparatus according to the first embodiment.

FIG. 6 is a flowchart illustrating an example of an operation of a warning notification method (processing, process) in the warning notification system according to the first embodiment.

FIG. 7 is a flowchart illustrating an example of an algorithm of determination processing according to the first embodiment.

FIG. 8 is a diagram illustrating an example of a block configuration of a warning notification system according to a second embodiment.

FIG. 9 is a flowchart illustrating an example of an operation of a warning notification method in the warning notification system according to the second embodiment.

FIG. 10 is a diagram illustrating an example of a block configuration of a warning notification system according to a third embodiment.

FIG. 11 is a flowchart illustrating an example of an operation of a warning notification method in the warning notification system according to the third embodiment.

FIG. 12 is a diagram illustrating an example of a block configuration of a warning notification system according to a fourth embodiment.

### DESCRIPTION OF EMBODIMENTS

### First Embodiment

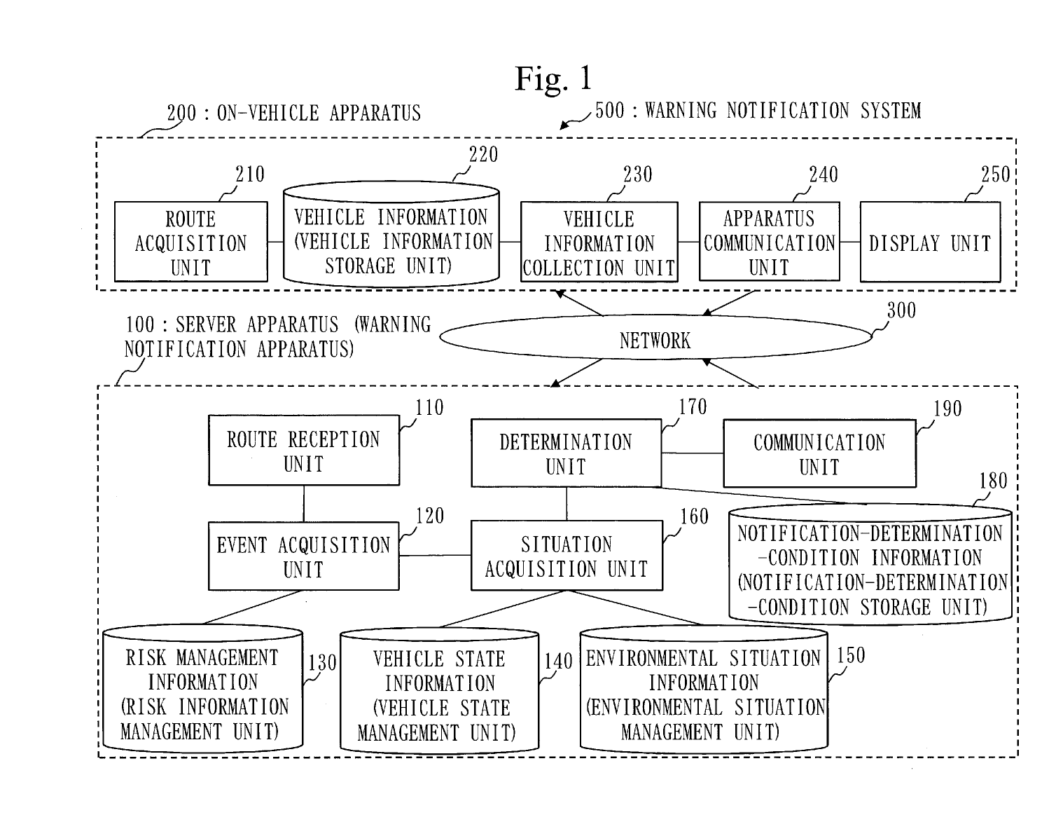

FIG. 1 is a block configuration diagram illustrating an example of a block configuration of a warning notification system 500 according to the present embodiment.

The warning notification system 500 is a driving support system that supports driving by issuing to a driver who drives a vehicle a warning relating to risk information and the like on a moving route on which the vehicle is scheduled to travel.

With reference to FIG. 1, the block configuration of the warning notification system 500 according to the present embodiment will be described.

As illustrated in FIG. 1, the warning notification system 500 includes a server apparatus 100 and an on-vehicle apparatus 200. The server apparatus 100 and the on-vehicle apparatus 200 are connected via a network 300.

The server apparatus 100 is, for example, a server computer located on a data center or the like, or another computer.

The server apparatus 100 is an example of a warning notification apparatus that is connected to the on-vehicle apparatus 200 mounted on the vehicle via the network 300 and issues the warning to the vehicle.

The server apparatus 100 includes a route reception unit 110, an event acquisition unit 120, a situation acquisition unit 160, a determination unit 170, and a communication unit 190. Further, a risk management information 130, a vehicle state information 140, an environmental situation information 150, and a notification-determination-condition information 180 are stored in a storage device included in the server apparatus 100.

The risk management information 130 is managed by a risk information management unit and stored in the storage device. The vehicle state information 140 is managed by a vehicle state management unit and stored in the storage device. The environmental situation information 150 is managed by an environmental situation management unit and stored in the storage device. The notification-determination-condition information 180 is stored in the storage device by an information-notification-condition storage unit.

The risk management information 130 is information obtained by associating a location on a map with a risk event (an example of an event) which may occur at that location on map information. The risk management information 130 is a so-called hazard map.

The warning notification system 500 collects occasionally from a member who joins to a warning notification service provided by the warning notification system 500, the risk information relating to the risk event having occurred during travelling of the vehicle. For example, the risk information management unit in the warning notification system 500 receives from the on-vehicle apparatus 200 a vehicle information 220 indicating a state of the vehicle, thereby generating the risk management information 130 based on the received vehicle information 220. As just described, the risk information management unit generates the risk management information 130 based on the risk information collected from the member.

Further, the vehicle state management unit of the server apparatus 100 stores the vehicle state information 140 indicating the state of the vehicle in the storage device for each vehicle, based on the vehicle information 220 received from the on-vehicle apparatus 200.

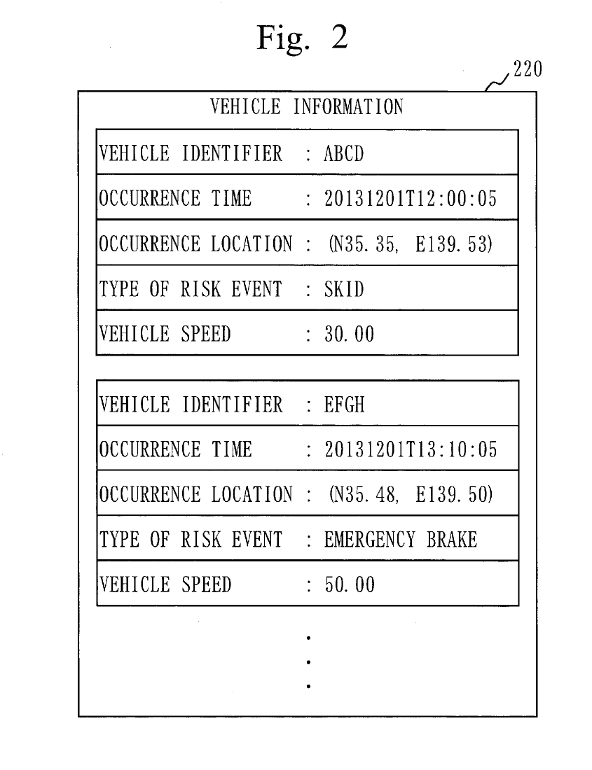

FIG. 2 is a diagram illustrating an example of a configuration of the vehicle information 220 according to the present embodiment.

As illustrated in FIG. 2, in the vehicle information 220, a vehicle identifier that identifies the vehicle, an occurrence time at which the risk event occurred, an occurrence location (latitude, longitude) where the risk event occurred, a type of the risk event, a vehicle speed at the time of the occurrence of the risk event, and the like, are set.

The vehicle state management unit stores the received vehicle information 220 in the storage device for each vehicle identifier and treats the received vehicle information 220 as the vehicle state information 140. Alternatively, the vehicle state management unit may accumulate the received vehicle information 220 as it is in the storage device.

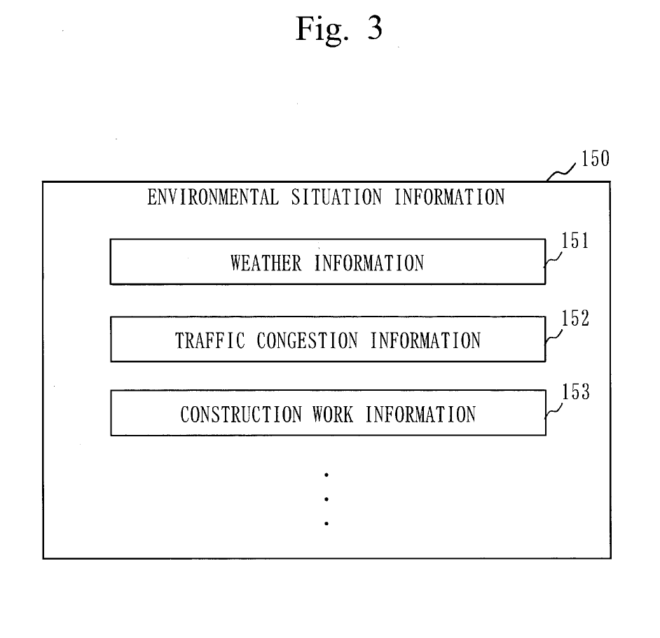

FIG. 3 is a diagram illustrating an example of a configuration of the environmental situation information 150 according to the present embodiment.

As illustrated in FIG. 3, the environmental situation information 150 includes a weather information 151, a traffic congestion information 152, a construction work information 153, and the like. The environmental situation information 150 such as the weather information 151, the traffic congestion information 152 and the construction work information 153 may be acquired based on the vehicle information 220 received from the vehicle.

For example, the environmental situation management unit may detect a traffic congestion location among locations on the map, based on the vehicle information 220 received from the on-vehicle apparatus 200. Alternatively, the environmental situation management unit may be acquired from an external weather database, a traffic congestion information database, a construction work information database, and the like.

Further, when the external weather database, the traffic congestion information database and the construction work information database are only used, the environmental situation information 150 may not be needed.

Referring back to FIG. 1, the description will be continued.

The route reception unit 110 receives from the on-vehicle apparatus 200 via the network 300, moving route information indicating the moving route of the vehicle. The moving route information is location information indicating the moving route.

Based on the risk management information 130, the event acquisition unit 120 acquires the risk information (an example of event information) representing the risk event associated with the moving route. The event associated with the moving route is a risk event associated to have a possibility to occur at a location on the moving route.

The risk event corresponds to, for example, events such as a skid, a sharp turn, an emergency brake, a lane reduction, a construction work, attention to a rear-end collision, attention to running out into traffic, and a bump. The risk event may be an event other than these risk events.

The risk information is information including the risk event and the risk location (an example of occurrence location information) associating with this risk event. The risk location is, for example, a location where the risk event occurred in the past.

The risk management information 130 is, for example, information in which the risk event such as a skid is related to the risk location indicating a location where the skid occurred.

The situation acquisition unit 160 acquires situation information representing a travelling situation. The situation acquisition unit 160 acquires, based on the vehicle state information 140 and the environmental situation information 150, the situation information representing the travelling situation of the vehicle.

The travelling situation is, for example, a situation of a road on the moving route along which the vehicle travels. In this case, the situation information is information indicating that road traffic is congested, road traffic is running smoothly, or the like. At this time, the situation acquisition unit 160 acquires the situation of the road within a specified range specified in advance from the location indicated by the risk location, as the situation information.

Further, the travelling situation includes, for example, a state of the vehicle. In this case, the situation information is information indicating a state in which the vehicle skids easily with a worn-out tire, a tendency of going fast, a tendency of frequent emergency brakes, and the like. As just described, the state of the vehicle includes a driving inclination of the driver and the like.

Further, the travelling situation includes, for example, weather at the time of travelling. In this case, the situation information is information indicating clear weather, rain, snow, heavy wind, and the like.

As just described, the situation acquisition unit 160 acquires, as the situation information, the situation of the road, the state of the vehicle, the weather, and the like.

The notification-determination-condition information 180 is information in which the risk event is related to a notification-determination-condition 181 for determining whether or not to issue the warning relating to this risk event. The notification-determination-condition storage unit stores the notification-determination-condition information 180 in the storage device.

The notification-determination-condition 181 is a condition for determining depending on the travelling situation whether or not to issue the warning, for example, a condition for determining depending on the situation of the road, a condition for determining depending on the state of the vehicle, a condition for determining depending on the weather, and the like. Accordingly, it can be said that the notification-determination-condition storage unit is used to store the condition for determining whether or not to issue the warning with respect to a certain risk event in each case of a plurality of travelling situations, as the notification-determination-condition.

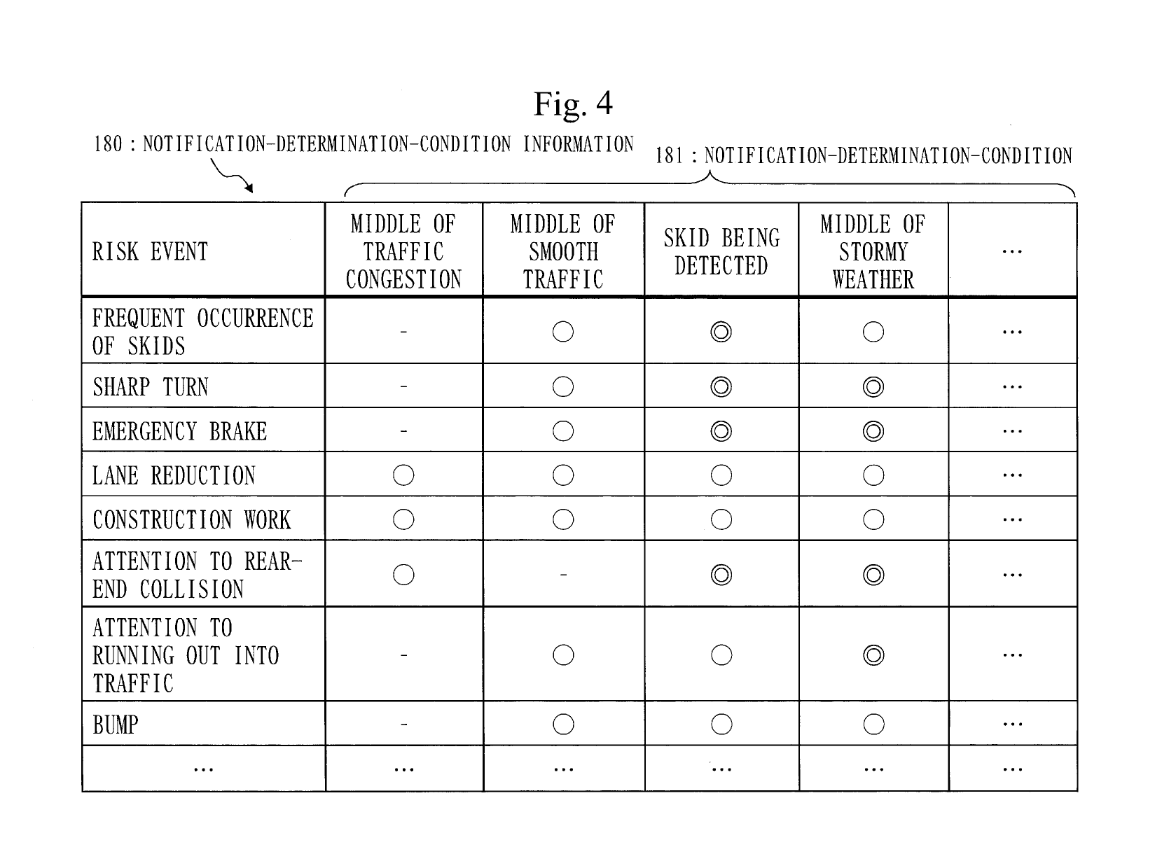

FIG. 4 is a diagram illustrating an example of a configuration of the notification-determination-condition information 180 according to the present embodiment.

As illustrated in FIG. 4, in the notification-determination-condition information 180, the risk event and the notification-determination-condition 181 for determining whether or not to issue the warning relating to this risk event, are set.

The notification-determination-condition 181 for determining whether or not to issue the warning with respect to the risk event in a certain travelling situation, is set. More specifically, the notification-determination-condition 181 is set to determine whether or not to issue the warning when the traffic congestion occurs, whether or not to issue the warning when the traffic is smooth, whether or not to issue the warning when the vehicle skid is detected, whether or not to issue the warning when the weather is stormy, and the like with respect to the risk event.

As just described, it is assumed that the notification-determination-condition 181 according to the present embodiment includes any one of the following conditions in one notification-determination-condition 181: a condition for determining whether or not to issue the warning depending on the situation of the road, a condition for determining whether or not to issue the warning depending on the state of the vehicle, and a condition for determining whether or not to issue the warning depending on the situation of the weather.

Therefore, the warning notification system 500 can simplify processing of the warning notification determination. Further, the warning notification system 500 can dynamically and flexibly change the condition with respect to the risk event only by changing the notification-determination-condition information 180 and can appropriately operate the warning notification determination.

In FIG. 4, a “hyphen”, a “circle”, and a “double circle” represent the presence or absence of the warning. The “hyphen” represents not to issue the warning. The “circle” represents to issue a normal notification. The “double circle” represents to issue an emphasized notification. The normal notification is to issue the warning by using a normal method. The emphasized notification is to issue the warning by further emphasizing the warning.

For example, if the normal notification is issued by displaying the warning in a normal displaying manner on a display device, the emphasized notification is issued by further emphasizing the warning compared with the normal notification, for example, by flashing the warning or displaying the warning with an alarm.

Further, each priority of the “double circle”, the “circle”, and the “hyphen” set in the notification-determination-condition information 180 is set as follows: priority of the “double circle”>priority of the “circle”>priority of the “hyphen”. For example, when a determination result to issue the emphasized notification and a determination result not to issue the warning are simultaneously obtained, the emphasized notification with higher priority is employed.

The determination unit 170 determines by a processing device whether or not to issue the warning, based on the notification-determination-condition 181 of the notification-determination-condition information 180 and the travelling situation represented by the situation information.

For example, in a case where the risk location whose risk event is “frequent occurrence of skids” exists on the moving route, when the situation information indicates clear weather, no vehicle skid being detected, and traffic congestion around the risk location, the determination unit 170 determines, based on the notification-determination-condition 181, not to issue the warning.

Alternatively, in a case where the risk location whose risk event is “frequent occurrence of skids” exists on the moving route, when the situation information indicates stormy weather, a vehicle skid being detected, and traffic congestion around the risk location, the “circle” is employed because of the stormy weather. However, since the priority of the “double circle”, which is employed because of the vehicle skid being detected, is higher than that of the “circle”, the determination unit 170 determines not to issue the normal notification but the emphasized notification.

Alternatively, in a case where the risk location whose risk event is “frequent occurrence of skids” exists on the moving route, when the situation information indicates stormy weather, no vehicle skid being detected, and traffic congestion around the risk location, the “circle” is employed because of the stormy weather. Thus, the determination unit 170 determines to issue the warning using the normal notification.

The determination unit 170 outputs to the communication unit 190 warning information including information indicating the contents of the warning and information indicating the strength of the warning.

The communication unit 190 transmits the warning information acquired from the determination unit 170 to the on-vehicle apparatus 200 via the network 300.

In the present embodiment, the determination unit 170 and the communication unit 190 are configured with different block configurations, but a single functional block may realize functions of the determination unit 170 and the communication unit 190. Note that, in this case, the classification to the “double circle”, the “circle”, and the “hyphen” are employed in order to have the priority in the notification-determination-condition 181. This classification is not necessarily made in this manner. A classification to simply the “circle” (issue the warning) and the “hyphen” (not to issue the warning) may be employed.

The network 300 is, for example, a combination of a mobile communication network and the Internet or the like.

The on-vehicle apparatus 200 is, for example, a navigation apparatus. Alternatively, the on-vehicle apparatus 200 may be a combination of the navigation apparatus or a DA (Display Audio) and a portable terminal (for example, a smart phone, a tablet, and a portable phone). As a part of the on-vehicle apparatus 200, a HUD (Head Up Display) may be also added.

The on-vehicle apparatus 200 includes a route acquisition unit 210, a vehicle information collection unit 230, an apparatus communication unit 240, and a display unit 250. Further, the on-vehicle apparatus 200 stores the vehicle information 220 in a storage device. The vehicle information 220 is stored in the storage device by a vehicle information storage unit.

The route acquisition unit 210 acquires the moving route information indicating the moving route of the vehicle. For example, the driver sets a destination to the on-vehicle apparatus 200 being the navigation apparatus, and thereby the route acquisition unit 210 acquires the moving route.

The vehicle information collection unit 230 collects information relating to a driving operation on an accelerator, a brake and a handle, and the like; information relating to a motion of the vehicle itself such as a vehicle speed, an acceleration, and a yaw rate; information obtained from a sensor such as a camera and a radar; and the like. The vehicle information collection unit 230 is realized by a hardware interface that collects the information from the sensor and the like. The vehicle information collection unit 230 may be the sensor itself. The vehicle information collection unit 230 may be implemented, as described below, as a program that executes a function of collecting the information from the sensor and the like.

The vehicle information storage unit stores the information collected by the vehicle information collection unit 230 in the storage device as the vehicle information 220.

The apparatus communication unit 240 receives the warning information from the communication unit 190 of the server apparatus 100.

The display unit 250 displays the warning on the display device based on the warning information received by the apparatus communication unit 240. The warning is not limited to a display of an image, but may be an audio notification, a vibration notification, or a combination of these.

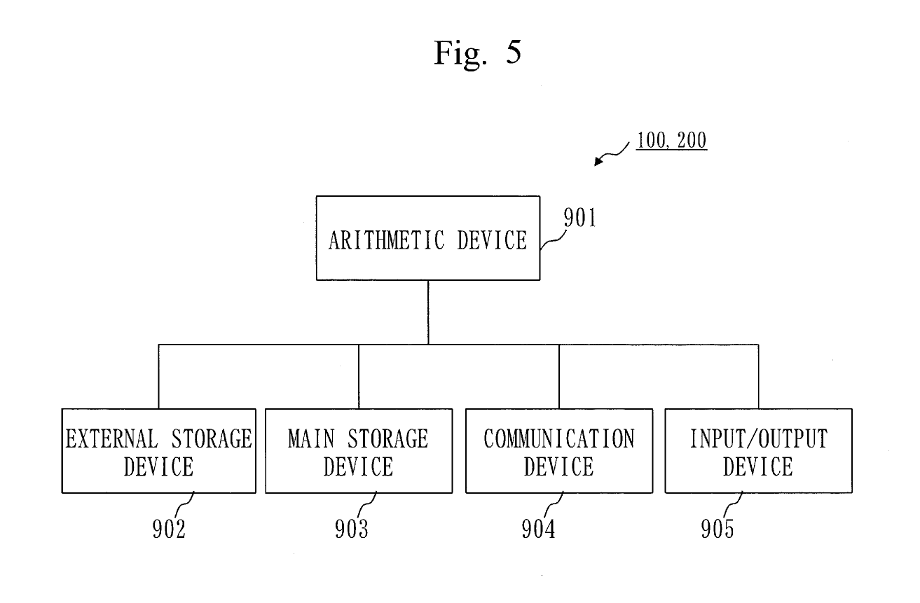

FIG. 5 is a diagram illustrating an example of a hardware configuration of the server apparatus 100 and the on-vehicle apparatus 200 according to the present embodiment.

With reference to FIG. 5, the example of the hardware configuration of the server apparatus 100 and the on-vehicle apparatus 200 will be described.

The server apparatus 100 and the on-vehicle apparatus 200 each is a computer, and each element of the server apparatus 100 and the on-vehicle apparatus 200 can be realized by a program.

As the hardware configuration of the server apparatus 100 and the on-vehicle apparatus 200, an arithmetic device 901, an external storage device 902, a main storage device 903, a communication device 904, and an input/output device 905 are connected to a bus.

The arithmetic device 901 is a CPU (Central Processing Unit) which executes the program. The arithmetic device 901 may be expressed such as, for example, a processing device, a Processor, or a Processing Circuitry.

The external storage device 902 is, for example, a ROM (Read Only Memory), a flash memory, or a hard disk device.

The main storage device 903 is a RAM (Random Access Memory).

The communication device 904 is, for example, a communication board or the like and connected to a LAN (Local Area Network) or the like. The communication device 904 is not necessarily connected to a LAN but may be connected to a WAN (Wide Area Network) such as an IP-VPN (Internet Protocol Virtual Private Network), a wide-area LAN, or an ATM (Asynchronous Transfer Mode) network; or the Internet. The LAN, the WAN, and the Internet are examples of a network.

The input/output device 905 is, for example, a mouse, a keyboard, a display device, or the like. A touch panel, a touch pad, a trackball, a pen tablet, or any other pointing device may be used in place of the mouse. The display device may be an LCD (Liquid Crystal Display), a CRT (Cathode Ray Tube), or any other display device. The display device is an example of the display unit 250 described in the embodiments.

The program is normally stored in the external storage device 902 and loaded into the main storage device 903 to be sequentially read and executed by the arithmetic device 901.

The program is a program that realizes each function described as a “unit” illustrated in the block configuration diagram.

A program product (a computer program product) is configured with a storage medium, a storage device, and the like which records the program that realizes the function of the “unit” illustrated in the block configuration diagram. The program product has a computer readable program loaded therein regardless of its appearance.

Further, an operating system (OS) is also stored in the external storage device 902. At least a part of the OS is loaded into the main storage device 903. The arithmetic device 901 executes, while executing the OS, the program that realizes the function of the “unit” illustrated in the block configuration diagram of FIG. 1.

Application programs are also stored in the external storage device 902. The application programs are loaded into the main storage device 903 and sequentially executed by the arithmetic device 901. For example, the program that realizes functions of the route reception unit 110, the event acquisition unit 120, the situation acquisition unit 160, and the determination unit 170; the risk management information 130; the vehicle state information 140; the environmental situation information 150; and the notification-determination-condition information 180 are stored in the external storage device 902. The arithmetic device 901 executes the above program using various information stored in the external storage device 902, thereby realizing processing. That is, the function of the “unit” illustrated in the block configuration diagram of FIG. 1 is realized by combining the arithmetic device 901 being hardware and the above program being software. In other words, the arithmetic device 901 is programmed to realize the function of the “unit” illustrated in the block configuration diagram of FIG. 1. Note that, the function is realized not only by the combination of the hardware and the software, but also solely by the hardware through implementing the above program to the arithmetic device 901.

Information such as a “table” is also stored in the external storage device 902. Information, data, signal values, and variable values indicating results of processes described as “evaluate”, “determine”, “extract”, “detect”, “set”, “register”, “select”, “generate”, “input”, “output”, and so on are stored in the main storage device 903.

Data that is received by the server apparatus 100 and the on-vehicle apparatus 200 is also stored in the main storage device 903.

An encryption key, a decryption key, a random number value, and a parameter may also be stored in the main storage device 903.

Note that, the configuration of FIG. 5 is merely the example of the hardware configuration of the server apparatus 100 and the on-vehicle apparatus 200. The hardware configuration of the server apparatus 100 and the on-vehicle apparatus 200 is not limited to the configuration of FIG. 5, but may be another configuration.

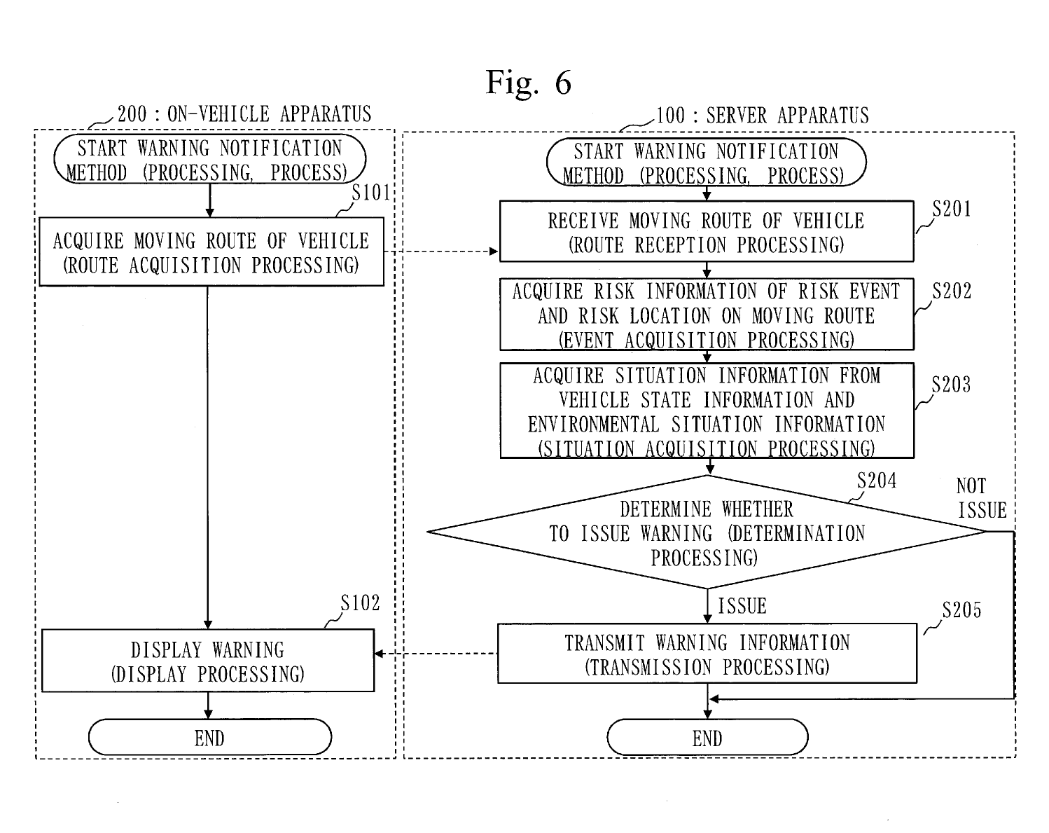

FIG. 6 is a flowchart illustrating an example of an operation of a warning notification method (processing, process) in the warning notification system 500 according to the present embodiment.

With reference to FIG. 6, the operation of the warning notification method (processing, process) in the warning notification system 500 according to the present embodiment will be described.

<Route Acquisition Processing (Process): S101>

In S101, the route acquisition unit 210 of the on-vehicle apparatus 200 acquires a travelling route of the vehicle as the moving route. The route acquisition unit 210 acquires the moving route which is from a present location to a destination of the vehicle, based on the destination set by a user in the on-vehicle apparatus 200 being the navigation apparatus. Alternatively, the route acquisition unit 210 may acquire, as the moving route, a road being within a predetermined range from the present location of the vehicle. Alternatively, the route acquisition unit 210 may acquire the moving route from the tendency of the past travelling route.

The route acquisition unit 210 transmits the acquired moving route to the server apparatus 100 via the network 300.

<Route Reception Processing (Process): S201>

In S201, the route reception unit 110 of the server apparatus 100 receives the moving route of the vehicle from the route acquisition unit 210 of the on-vehicle apparatus 200 via the network 300.

<Event Acquisition Processing (Process): S202>

In S202, the event acquisition unit 120 acquires the risk information representing the risk event associated with the location on the moving route, based on the moving route received by the route reception unit 110 and on the risk management information 130.

For example, it is assumed that the event acquisition unit 120 acquires, as the risk information, a risk location A where skids frequently occur and a risk location B to be careful of a rear-end collision on the moving route.

<Situation acquisition processing (process): S203>

In S203, the situation acquisition unit 160 acquires the situation information representing the travelling situation of the vehicle, based on the risk information acquired by the event acquisition unit 120, the vehicle state information 140, and the environmental situation information 150.

For example, the situation acquisition unit 160 acquires, as the situation information indicating the travelling situation of the vehicle, the traffic congestion information on the moving route within a specified range specified in advance from the risk location A. Further, the situation acquisition unit 160 acquires, as the situation information, the traffic congestion information on the moving route within a specified range specified in advance from the risk location B.

Here, the range specified in advance can be set by a system manager of the warning notification system 500. For example, the range is specified such as within a range of 10 meters, within a range of 50 meters, or within a range of 100 meters.

Further, the situation acquisition unit 160 acquires, as the situation information, weather in a vicinity of the risk location A and a vicinity of the risk location B.

Further, the situation acquisition unit 160 acquires, as the situation information, a condition of the vehicle to which the acquired moving route is set.

For example, the situation acquisition unit 160 acquires, as the situation information, information indicating traffic congestion at the risk location A and also at the risk location B, no vehicle skid being detected, clear weather, and the like.

<Determination Processing (Process): S204>

In S204, the determination unit 170 refers to the notification-determination-condition information 180, based on the risk event on the moving route acquired by the event acquisition unit 120 and the situation information acquired by the situation acquisition unit 160, and determines by the processing device whether or not to issue the warning.

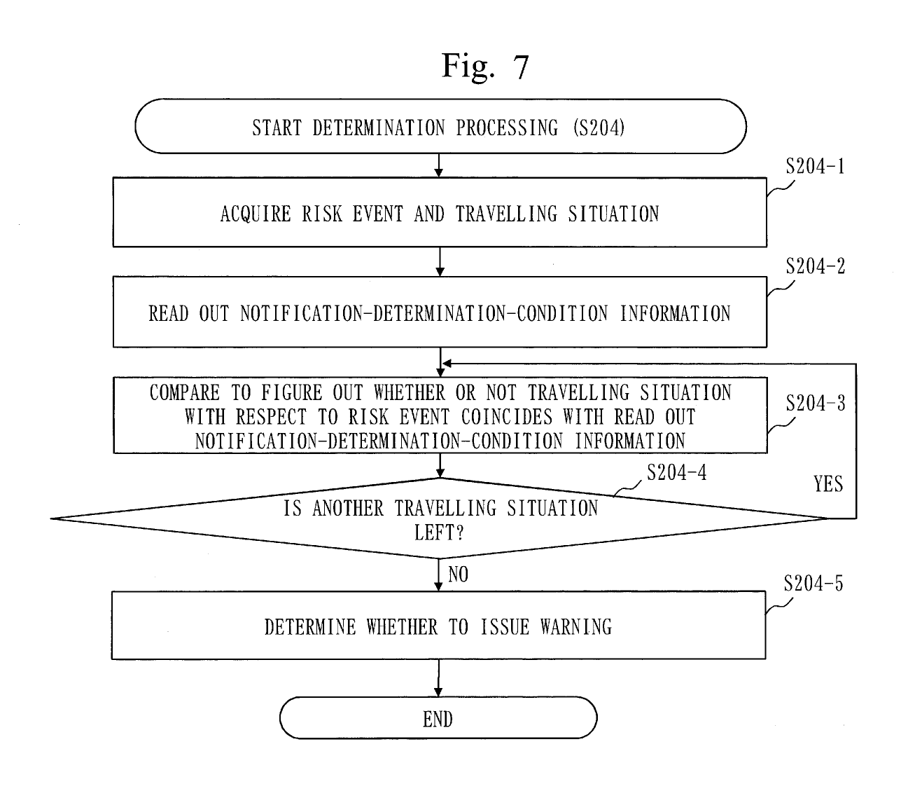

FIG. 7 is a flowchart illustrating an example of an algorithm of the determination processing according to the present embodiment. The arithmetic device 901 is programmed to execute the determination processing by the determination unit 170, that is, the algorithm illustrated in FIG. 7 (from the processing of step S204-1 to the processing of step S204-5), thereby realizing the determination processing of step S204.

Firstly, the determination unit 170 acquires the risk event from the event acquisition unit 120 and acquires from the situation acquisition unit 160 the travelling situation represented in the situation information (step S204-1).

Next, the determination unit 170 reads out the notification-determination-condition information 180 from the storage device (step S204-2).

Next, the determination unit 170 compares to figure out whether or not the acquired travelling situation with respect to the risk event coincides with the read out travelling situation of the notification-determination-condition information 180 (step S204-3). Here, the risk event acquired by the determination unit 170 is “frequent occurrence of skids”, and the travelling situation acquired by the determination unit 170 is “traffic congestion”, “no vehicle skid being detected” and “clear weather”. Hence, the determination unit 170 firstly reads out the notification-determination-condition 181 which indicates “in the middle of traffic congestion” corresponding to the frequent occurrence of skids in the notification-determination-condition information 180 and compares it to the acquired travelling situation. Here, the “hyphen” is illustrated in the middle of the traffic congestion in FIG. 4. Hence, the warning is not issued.

Next, the determination unit 170 determines whether another travelling situation is left (step S204-4). Here, the acquired travelling situations which are “no vehicle skid being detected” and “clear weather” are left, so that the determination unit 170 repeatedly performs the processing of step S204-3. If no travelling situation is left, the processing proceeds to step S204-5, and the determination unit 170 determines whether or not to issue the warning. Here, the travelling situations are “traffic congestion”, “no vehicle skid being detected” and “clear weather”. As a result, the determination unit 170 determines not to issue the warning of “frequent occurrence of skids” at the vicinity of the risk location A. This means that the determination unit 170 has determined that the warning is not necessary because tires of the vehicle are normal and the weather is clear, so that it is considered that a skid under the traffic congestion hardly occurs.

Further, the determination unit 170 executes the processing by using the same algorithm when the risk event in the notification determination is attention to a rear-end collision. As a result, the determination unit 170 determines from the travelling situations (traffic congestion, no vehicle skid being detected, and clear weather) in the situation information to issue the warning of “attention to a rear-end collision” at the vicinity of the risk location B. It means that the determination unit 170 has determined that the warning is necessary because there is a high risk of causing a rear-end collision even under the traffic congestion.

Referring back to FIG. 6, when the determination unit 170 determines not to issue the warning (not issue in S204), the processing ends.

When the determination unit 170 determines to issue the warning (issue in S204), the processing proceeds to S205.

<Transmission Processing (Process): S205>

The communication unit 190 receives from the determination unit 170 the warning information for displaying the warning. The warning information includes information indicating the contents of the warning and information indicating the strength of the warning.

For example, the determination unit 170 determines from the situation information (the traffic congestion, the vehicle skid being detected, and the clear weather) to issue the emphasized the warning of “attention to a rear-end collision” at the vicinity of the risk location B. The determination unit 170 outputs the warning information including the warning of “attention to a rear-end collision” and the emphasized notification to the communication unit 190.

Alternatively, the determination unit 170 determines from the situation information (the traffic congestion, no vehicle skid being detected, and the stormy weather) to issue the normal the warning of “frequent occurrence of skids” at the vicinity of the risk location A. The determination unit 170 outputs the warning information including the warning of “frequent occurrence of skids” and the normal notification to the communication unit 190.

The communication unit 190 transmits the warning information received from the determination unit 170 to the on-vehicle apparatus 200 via the network 300.

<Display Processing (Process): S102>

The apparatus communication unit 240 of the on-vehicle apparatus 200 receives the warning information from the communication unit 190 of the server apparatus 100.

The display unit 250 displays the waning on the display device based on the warning information received by the apparatus communication unit 240. As a method to issue the warning, in addition to a method of displaying the warning on the display device, for example, the warning may be issued by voice sound. In a case of the normal notification, an announcement such as “Please be careful of a skid” may be output by the voice sound, and in a case of the emphasized notification, a tensed announcement such as “Danger! Danger! Be careful of a rear-end collision!” may be output by the voice sound. Further, the warning may be issued by vibration. In a case of the normal notification, normal vibration may be used, and in a case of the emphasized notification, the warning may be issued by vibration which is stronger than the normal vibration. Further, voice sound, a display to the display device and vibration may be combined to issue the warning.

The warning notification method (processing, process) in the warning notification system 500 according to the present embodiment has been described above.

Note that, in the description of the notification-determination-condition information 180 of FIG. 4, it is assumed that the priority is set in the order of the priority of the “double circle”>the priority of the “circle”>the priority of the “hyphen”.

However, as a method for setting the priority, for example, priority information representing priority of each of a plurality of notification-determination-conditions 181 may be added to each of the plurality of notification-determination-conditions 181. Then, the determination unit 170 may select at least one notification-determination-condition 181 from the plurality of notification-determination-conditions 181, based on the priority added to each of the plurality of notification-determination-conditions 181. The determination unit 170 may execute the notification determination processing based on the selected at least one notification-determination-condition 181.

Further, timing for the warning notification system 500 to display the warning on the display device may be set, for example, at a point which is a predetermined specified distance before the risk location. For example, the timing is set by the system manager at a point such as 3 kilometers or 2 kilometers before the risk location. Alternatively, when the driver sets the moving route to the on-vehicle apparatus 200, the warning may be issued immediately.

As described above, the notification determination storage unit stores a plurality of travelling situations with respect to the risk event and the propriety of the warning in each case, as the notification-determination-condition 181, and the determination unit determines whether or not to issue the warning, based on the notification-determination-condition 181 and the travelling situation of the vehicle. Thus, according to the warning notification system 500 of the present embodiment, it is avoided to issue the warning only when each of the travelling situation of the vehicle and the situation at the time of the occurrence of the accident is identical to a certain situation, and it is possible to appropriately issue the warning relating to the risk information. For example, according to the warning notification system 500 of the present embodiment, when a point where the vehicle is going to pass is, for example, a risk location having properties such as frequent occurrence of skids or a sharp turn, the warning is issued to the driver as long as traffic congestion does not occur at the location. This is because when the traffic congestion occurs and the vehicle passes the location slowly, the warning is meaningless to the driver.

Similarly, it is also possible that when the number of vehicles passing through the location are remarkably small, the warning of attention to a rear-end collision is not issued.

Further, according to the warning notification system 500 of the present embodiment, when a point where the vehicle is going to pass is under traffic congestion, it is possible to acquire and issue the risk information at a point on a detour route. When the point where the vehicle is going to pass is under traffic congestion, the warning notification system 500 acquires the detour route and realizes acquiring and issuing the risk information by executing the warning notification processing described above using the acquired detour route as the moving route.

Further, with regard to frequent occurrence of skids, issuing the warning or not has been determined by detecting whether or not tires of the vehicle are skidded. However, for example, the warning may be issued when tires of a preceding car around the vehicle are actually skidded.

Further, according to the warning notification system 500 of the present embodiment, the necessity of the warning is determined on the server apparatus side, and the warning information is transmitted to the on-vehicle apparatus side only when the notification is necessary. Thus, an amount of information can be reduced and a load on the network can be reduced.

Further, according to the warning notification system 500 of the present embodiment, depending on the contents of the risk event, it can be precisely determined whether or not to issue the warning relating to the risk event. Further, only one type of a condition is determined as one notification-determination-condition, so that the determination processing can be simplified. Further, the notification-determination-condition can be easily changed.

As just described, according to the warning notification system 500 of the present embodiment, an unnecessary warning such that the warning of frequent occurrence of skids is issued in the middle of traffic congestion is reduced, and an accurate warning such that an warning is displayed in an emphasized manner whenever the vehicle tends to skid easily can be also realized. Further, the load on the network can be reduced.

### Second Embodiment

In the present embodiment, a difference from the first embodiment will mainly be described.

In the present embodiment, the same reference sign is assigned to the same component unit having the same function as the component units described in the first embodiment, and the description of the component unit may be omitted.

In the first embodiment, the on-vehicle apparatus 200 transmits the moving route to the server apparatus 100, and the server apparatus 100 acquires the risk information on the moving route. The determination unit 170 determines the necessity of the warning and transmits the warning information to the on-vehicle apparatus 200 when the notification is required.

In the present embodiment, a method will be described in which the server apparatus 100 transmits the risk information and the situation information acquired by the event acquisition unit 120 and the situation acquisition unit 160 to the on-vehicle apparatus 200, and the on-vehicle apparatus 200 determines the necessity of the warning. The on-vehicle apparatus 200 is an example of a warning notification apparatus that determines the necessity of the warning.

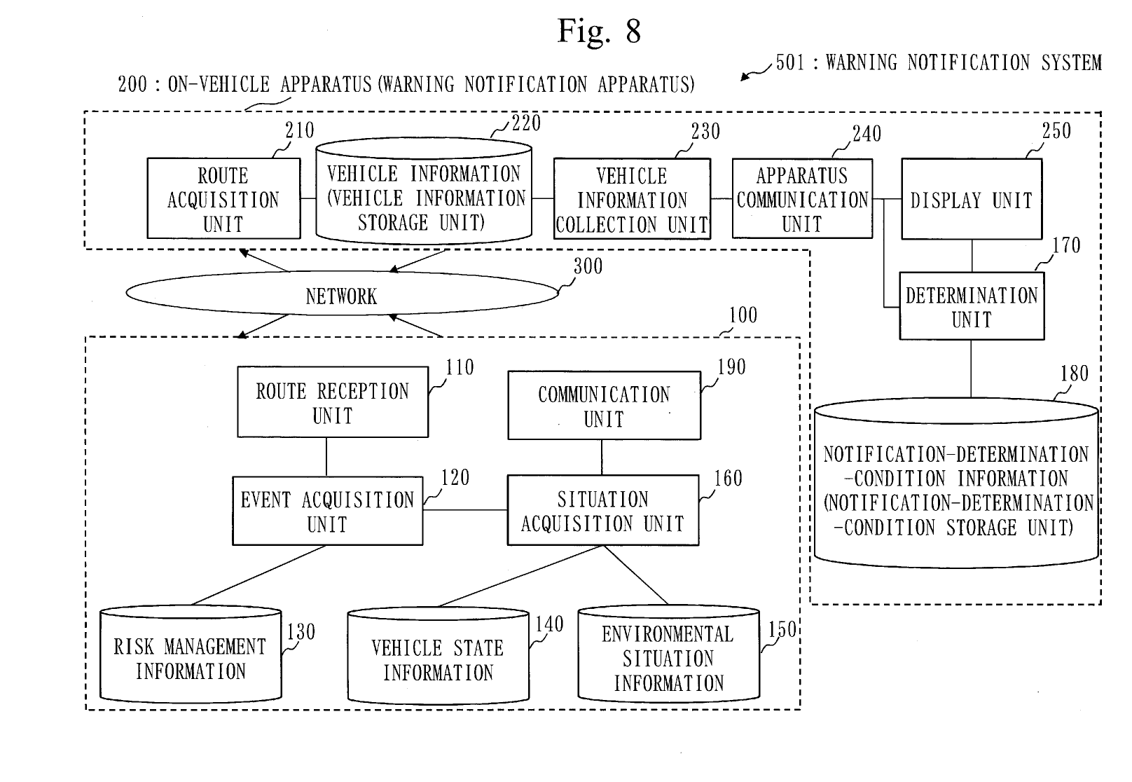

FIG. 8 is a diagram illustrating an example of a block configuration of a warning notification system 501 according to the present embodiment.

As illustrated in FIG. 8, the on-vehicle apparatus 200 includes, in addition to the configuration described in the first embodiment, the determination unit 170 and the notification-determination-condition information 180. Also, unlike the configuration described in the first embodiment, the server apparatus 100 does not include the determination unit 170 and the notification-determination-condition information 180.

Function configurations of the determination unit 170 and the notification-determination-condition information 180 are the same as those described in the first embodiment.

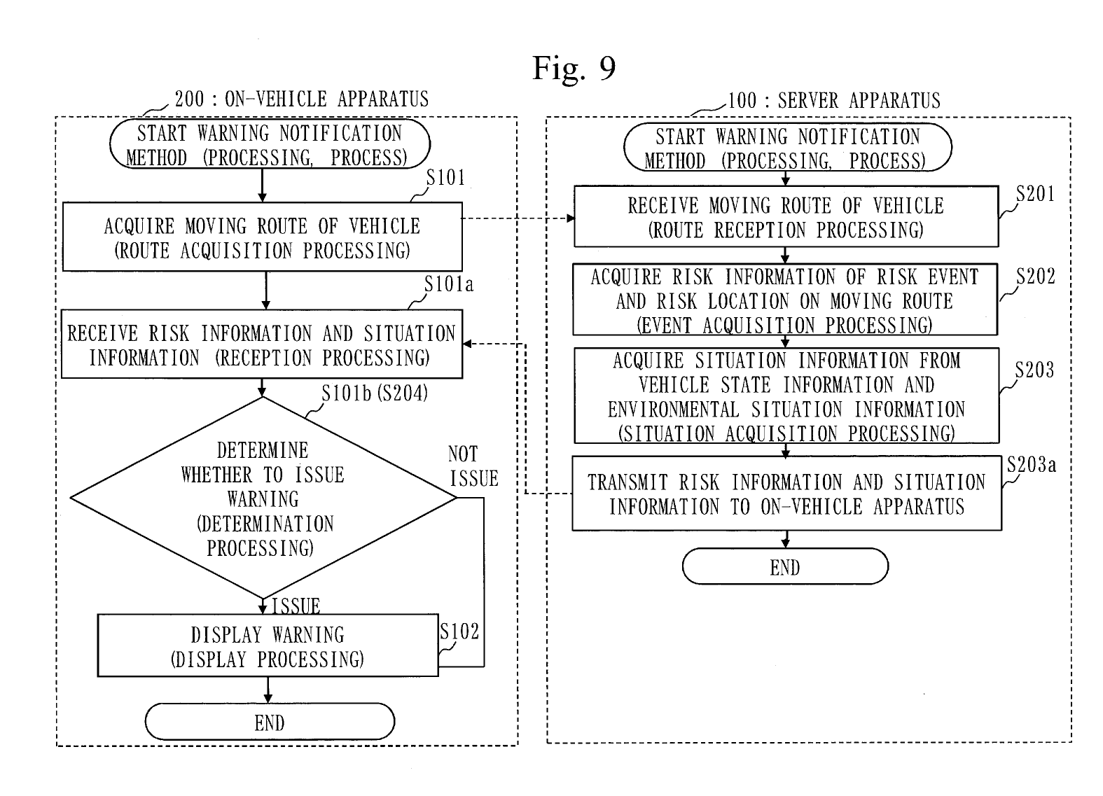

FIG. 9 is a flowchart illustrating an example of an operation of a warning notification method in the warning notification system 501 according to the present embodiment.

With reference to FIG. 9, the example of the operation of the warning notification method in the warning notification system 501 will be described.

In FIG. 9, the processing from S101 to S203 is the same as the processing from S101 to S203 described in FIG. 6 of the first embodiment.

In S203a, the communication unit 190 transmits the risk information acquired by the event acquisition unit 120 and the situation information acquired by the situation acquisition unit 160 to the on-vehicle apparatus 200.

<Reception Processing (Process): S101a>

In S101a, the apparatus communication unit 240 receives the risk information and the situation information from the server apparatus 100.

<Determination Processing (Process): S101b>

The processing of S101b is the same as the processing of S204 described in FIG. 6 of the first embodiment. That is, the determination unit 170 of the on-vehicle apparatus 200 acquires the risk information and the situation information via the apparatus communication unit 240. The determination unit 170 refers to the notification-determination-condition information 180 based on the situation information and determines the necessity of the warning with respect to the risk event. Then, when the determination unit 170 determines to issue the warning, the determination unit 170 outputs the risk information including the contents of the warning and the notification method to the display unit 250.

In S102, the display unit 250 displays the warning on the display device in accordance with the warning information. The processing of S102 is the same as the processing of S102 described in FIG. 6 of the first embodiment.

The operation of the warning notification method in the warning notification system 501 according to the present embodiment has been described above.

As described above, according to the warning notification system 501 of the present embodiment, the on-vehicle apparatus 200 includes the notification-determination-condition information 180. Thus, the notification-determination-condition can be changed dynamically on a vehicle side (a driver side). For example, in a case where a driver tends to drive with relatively fast speed, in a case where an elderly person drives a vehicle, and the like, a requirement to issue the warning may be less strict and the requirement can be set which enables the warning to be issued frequently. On the other hand, in a case where a driver is an experienced driver, a driver with high driving technique, or the like, a requirement to issue the warning may be strict, and the requirement can be set which enables the warning to be issued only when it is truly necessary.

Note that, a concept of the warning notification system described above is not limited to the system configured with the server apparatus 100 and the on-vehicle apparatus 200, that is, the system configured with a plurality of devices, but may be the server apparatus 100 itself, or the on-vehicle apparatus 200 itself. That is, the warning notification system may be addressed to the server apparatus 100, or the server apparatus 100 including one, some or all of the functions of the on-vehicle apparatus 200. Further, the warning notification system may refer to the on-vehicle apparatus 200, or the on-vehicle apparatus 200 including one, some or all of the functions of the server apparatus 100. The same matter applies to the following description.

### Third Embodiment

In the present embodiment, a difference from the first and second embodiments will mainly be described.

In the present embodiment, the same reference sign is assigned to the same component unit having the same function as the component units described in the first and second embodiments, and the description of the component unit may be omitted.

In the present embodiment, a case will be described where a portable terminal apparatus 400 carried by a user is used as a navigation apparatus. The portable terminal apparatus 400 is, for example, a smart phone, a tablet terminal, or the like.

In the present embodiment, a method will be described in which the server apparatus 100 transmits the risk information and the situation information acquired by the event acquisition unit 120 and the situation acquisition unit 160 to the portable terminal apparatus 400, and the portable terminal apparatus 400 determines the necessity of the warning. The portable terminal apparatus 400 is an example of a warning notification apparatus that determines the necessity of the warning.

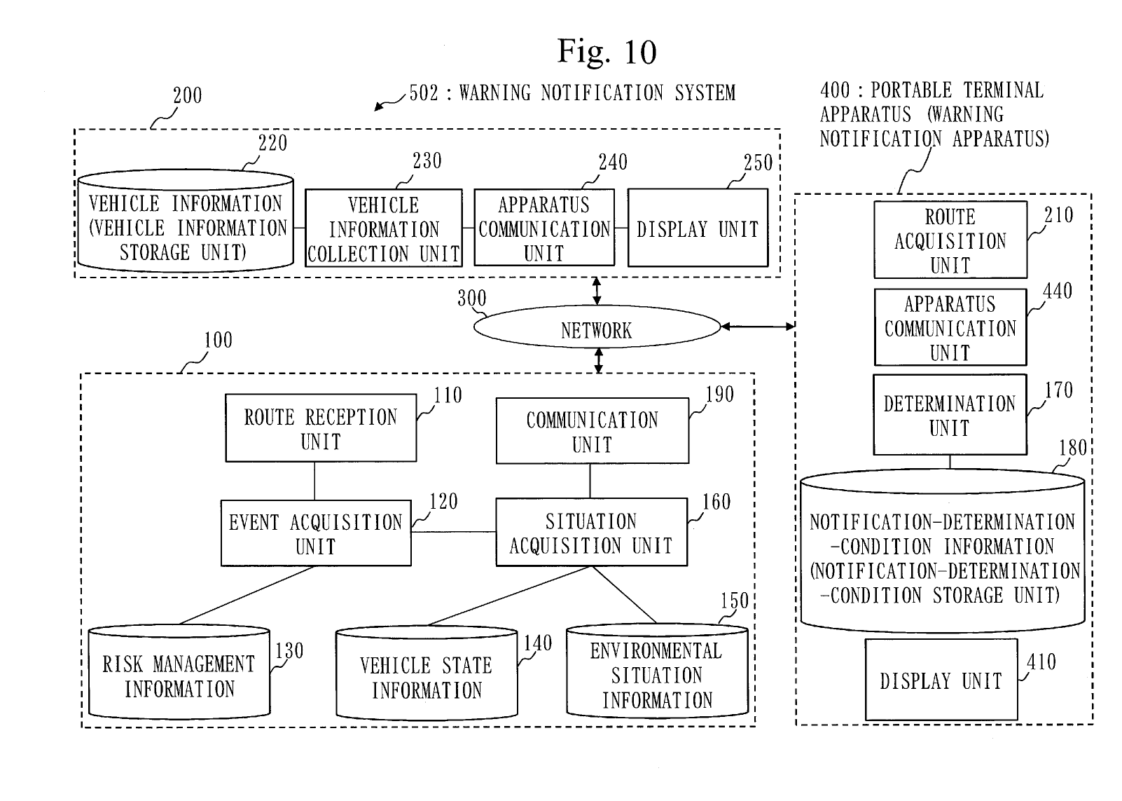

FIG. 10 is a diagram illustrating an example of a block configuration of a warning notification system 502 according to the present embodiment.

As illustrated in FIG. 10, the warning notification system 502 includes the server apparatus 100, the on-vehicle apparatus 200, and the portable terminal apparatus 400. The server apparatus 100, the on-vehicle apparatus 200, and the portable terminal apparatus 400 are connected to each other via the network 300.

The portable terminal apparatus 400 includes the route acquisition unit 210, the determination unit 170, the notification-determination-condition information 180, a display unit 410, and an apparatus communication unit 440. Difference from the first and second embodiments is that the server apparatus 100 does not include the determination unit 170 and the notification-determination-condition information 180 and the on-vehicle apparatus 200 does not include the route acquisition unit 210.

An application for the navigation apparatus is deployed on the portable terminal apparatus 400. The portable terminal apparatus 400 functions as the navigation apparatus.

Function configurations of the route acquisition unit 210, the determination unit 170, and the notification-determination-condition information 180 are the same as those described in the first embodiment.

The display unit 410 displays map information, destination information, and the like when the portable terminal apparatus 400 functions as the navigation apparatus. Further, the display unit 410 displays the warning on the display device, the warning being determined by the determination unit 170 that the notification is necessary.

The apparatus communication unit 440 executes a communication between the server apparatus 100 and the on-vehicle apparatus 200 connected to the portable terminal apparatus 400 via the network 300.

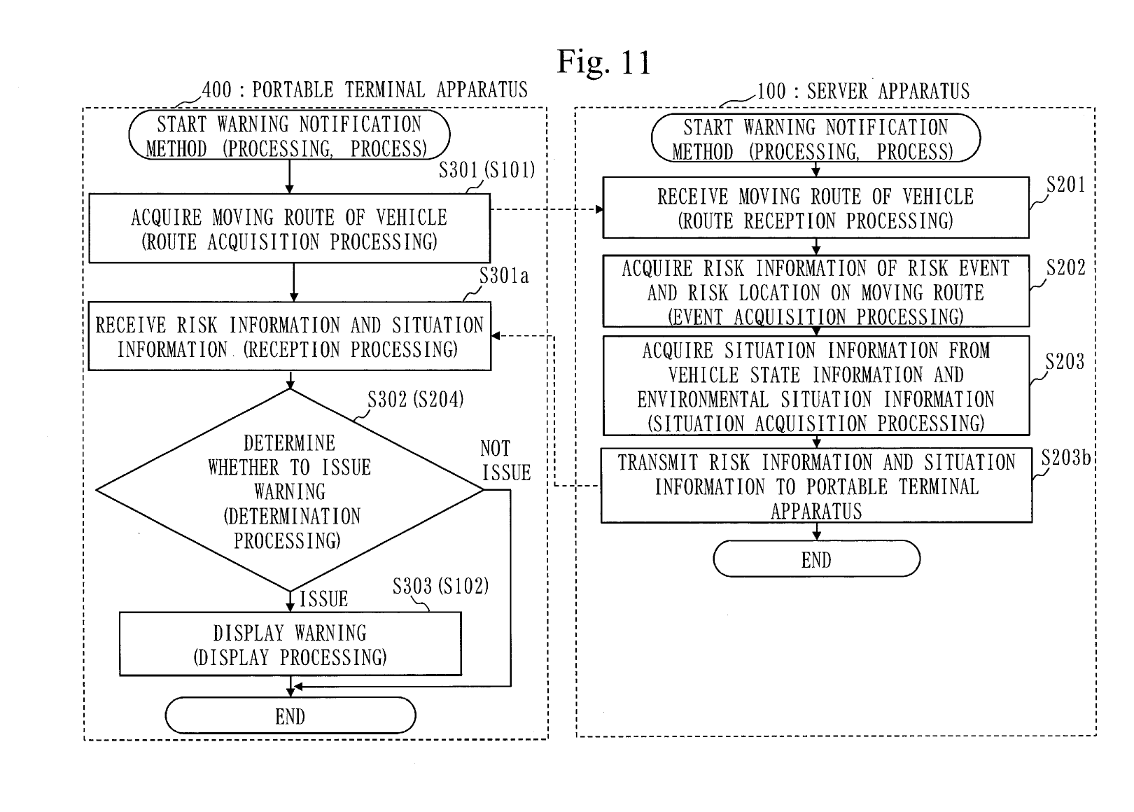

FIG. 11 is a flowchart illustrating an example of an operation of a warning notification method in the warning notification system 502 according to the present embodiment.

With reference to FIG. 11, the example of the operation of the warning notification method in the warning notification system 502 will be described.

In S301, the route acquisition unit 210 of the portable terminal apparatus 400 acquires the travelling route of the vehicle as the moving route. The route acquisition unit 210 acquires the moving route from the present location to a destination of the vehicle, based on the destination set by the user in the portable terminal apparatus 400 being the navigation apparatus. The processing of S301 is the same as the processing of S101 described in FIG. 6 of the first embodiment.

In FIG. 11, the processing from S201 to S203 is the same as the processing from S201 to S203 described in FIG. 6 of the first embodiment.

In S203b, the communication unit 190 transmits the risk information acquired by the event acquisition unit 120 and the situation information acquired by the situation acquisition unit 160 to the portable terminal apparatus 400 (a smart phone, or a tablet terminal).

In S301a, the apparatus communication unit 440 receives the risk information and the situation information from the server apparatus 100.

The processing of S302 is the same as S204 described in FIG. 6 of the first embodiment. That is, the determination unit 170 of the portable terminal apparatus 400 acquires the risk information and the situation information from the server apparatus 100. The determination unit 170 refers to the notification-determination-condition information 180 based on the situation information and determines the necessity of the warning with respect to the risk event. Then, when the determination unit 170 determines to issue the warning, the determination unit 170 outputs the warning information including the contents of the warning and the notification method to the display unit 410. When the determination unit 170 acquires the warning information, the display unit 410 displays the warning on the display device based on the acquired warning information.

When the determination unit 170 determines to issue the warning, the determination unit 170 may transmit the warning information including the contents of the warning and the notification method to the on-vehicle apparatus 200. The apparatus communication unit 240 of the on-vehicle apparatus 200 receives the warning information, thereby outputting the warning information to the display unit 250 of the on-vehicle apparatus 200. The display unit 250 of the on-vehicle apparatus 200 displays the warning on the display device of the on-vehicle apparatus 200.

Alternatively, when the determination unit 170 determines to issue the warning, the determination unit 170 outputs the warning information to the display unit 410 and may also transmit the warning information to the on-vehicle apparatus 200.

In S303, the display unit 410 displays the warning on the display device in accordance with the warning information. The processing of S303 is the same as S102 described in FIG. 6 of the first embodiment.

The operation of the warning notification method in the warning notification system 502 according to the present embodiment has been described above.

As described above, according to the warning notification system 502 of the present embodiment, the portable terminal apparatus 400 that functions as the navigation apparatus includes the notification-determination-condition information 180. Thus, the notification-determination-condition can be changed dynamically on a vehicle side (a driver side). Further, even when the vehicle is replaced, a warning notification service by the warning notification system 502 can be easily provided.

### Fourth Embodiment

In the present embodiment, a difference from the first to third embodiments will mainly be described. In particular, a difference from the third embodiment will be described.

In the present embodiment, the same reference sign is assigned to the same component unit having the same function as the component units described in the first to third embodiments, and the description of the component unit may be omitted.

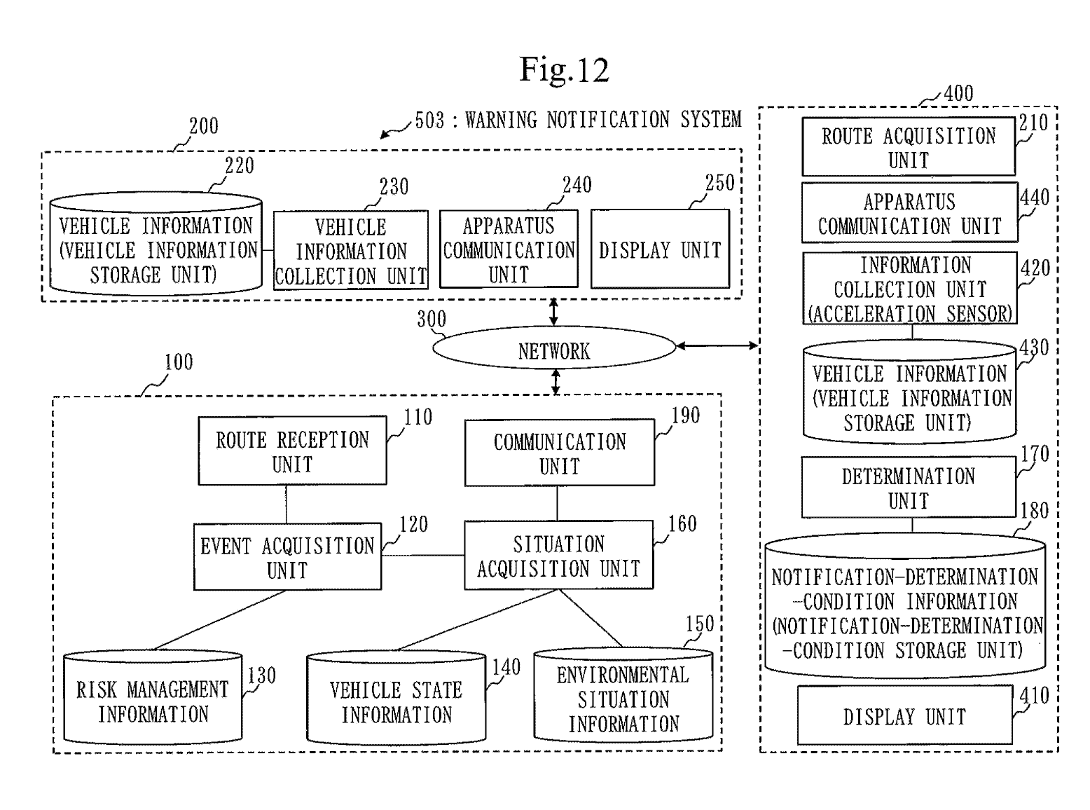

FIG. 12 is a diagram illustrating an example of a block configuration of a warning notification system 503 according to the present embodiment. FIG. 12 is the diagram corresponds to FIG. 10 described in the third embodiment.

In FIG. 12, difference from FIG. 10 is that the portable terminal apparatus 400 includes a vehicle information collection unit 420 and a vehicle information 430.

The vehicle information collection unit 420 collects, for example, using an acceleration sensor included in a smart phone, information related to a vehicle movement such as a vehicle speed, an acceleration, a yaw rate, an emergency brake, and an emergency brake of another vehicle.

The vehicle information storage unit stores information collected by the vehicle information collection unit 420 as the vehicle information 430 to the storage device.

The vehicle information 430 collected by the vehicle information collection unit 420 is transmitted to the server apparatus 100 via the network 300. The server apparatus 100 generates the risk management information 130 and the vehicle state information 140 based on the vehicle information 430 received from the portable terminal apparatus 400.

According to the warning notification system 503 of the present embodiment, function configurations except for those of the vehicle information collection unit 420 and the vehicle information 430 are the same as those described in the first to third embodiments.

As described above, according to the warning notification system 503 of the present embodiment, the portable terminal apparatus 400 that functions as the navigation apparatus includes the vehicle information collection unit 420. Thus, even when the vehicle is replaced, a state of the vehicle can be obtained easily. Therefore, even when the vehicle is replaced, the warning notification service by the warning notification system 502 can be continuously provided easily.

Note that, a concept of the warning notification system described in the third and fourth embodiment is not limited to the system configured with the server apparatus 100, the on-vehicle apparatus 200, and the portable terminal apparatus 400, that is, the system configured with a plurality of devices, but may be the portable terminal apparatus 400 itself. That is, the warning notification system may be addressed to the portable terminal apparatus 400 itself. Further, the functional blocks of the warning notification system described in the third and fourth embodiments may be arranged distributedly in any manner in the server apparatus 100, the on-vehicle apparatus 200, and the portable terminal apparatus 400.

Note that, the block configuration of the warning notification system is not limited to the block configurations described in the first to fourth embodiments above. Another configuration of the functional block may be employed and realized.

For example, in the warning notification system, the event acquisition unit and the situation acquisition unit may form a single functional block, and the determination unit and the communication unit may form a single functional block.

Various changes can be made to the functional block as needed as far as they are not contradictory, and the block configuration above is an arbitrary. Further, the functional blocks described in the first to fourth embodiments may be arranged distributedly in any manner in the warning notification system as far as they are not contradictory.

The embodiments of the present invention have been described above. Of the embodiments above, two or more of the embodiments may be combined and performed. Alternatively, of the embodiments above, one of the embodiments may be partially performed. Alternatively, of the embodiments above, two or more of the embodiments may be partially performed.

Note that, the embodiments above are essentially preferable exemplifications and are not intended to limit the present invention, a product to which the present invention has been applied, or the scope of usage of the present invention. Various changes can be made to the embodiments above as needed as far as they are not contradictory.

### REFERENCE SIGNS LIST

100: server apparatus; 110: route reception unit; 120: event acquisition unit; 130: risk management information; 140: vehicle state information; 150: environmental situation information; 160: situation acquisition unit; 170: determination unit; 180: notification-determination-condition information; 181: notification-determination-condition; 190: communication unit; 200: on-vehicle apparatus; 210: route acquisition unit; 220: vehicle information; 230: vehicle information collection unit; 240: apparatus communication unit; 250: display unit; 300: network; 400: portable terminal apparatus; 410: display unit; 420: vehicle information collection unit; 430: vehicle information; 440: apparatus communication unit; 500, 501, 502, 503: warning notification system; 901: arithmetic device; 902: external storage device; 903: main storage device; 904: communication device; and 905: input/output device.

1.-14. (canceled)

15. A warning notification system comprising:
a route acquisition unit to acquire moving route information indicating a moving route of a vehicle;
an event acquisition unit to acquire event information representing an event associated with the moving route information acquired by the route acquisition unit;
a situation acquisition unit to acquire situation information representing a travelling situation of the vehicle;
a notification-determination-condition storage unit to store a condition for determining whether or not to issue a warning with respect to the event information acquired by the event acquisition unit in each case of a plurality of travelling situations, as a notification-determination-condition; and
a determination unit to determine whether or not to issue the warning, based on the notification-determination-condition stored in the notification-determination-condition storage unit and the situation information acquired by the situation acquisition unit, wherein
the notification-determination-condition storage unit adds priority information representing priority of each of a plurality of notification-determination-conditions to the plurality of the notification-determination-conditions, and stores the plurality of notification-determination-conditions, and
the determination unit selects at least one notification-determination-condition from the plurality of notification-determination-conditions, based on the priority information added to each of the plurality of notification-determination-conditions, and determines whether or not to issue the warning, based on the selected at least one notification-determination-condition.

16. The warning notification system according to claim 15, wherein
the event acquisition unit further acquires occurrence location information indicating a location where the event occurred,
the notification-determination-condition storage unit stores a condition for determining depending on a situation of a road whether or not to issue the warning, as the notification-determination-condition, and
the situation acquisition unit acquires the situation of the road within a specified range specified in advance from the location indicated by the occurrence location information, as the situation information.

17. The warning notification system according to claim 15, wherein
the notification-determination-condition storage unit stores a condition for determining depending on a state of the vehicle whether or not to issue the warning, as the notification-determination-condition, and
the situation acquisition unit acquires the state of the vehicle as the situation information.

18. The warning notification system according to claim 15, wherein
the notification-determination-condition storage unit stores a condition for determining depending on a state of weather whether or not to issue the warning, as the notification-determination-condition, and
the situation acquisition unit acquires the state of weather as the situation information.

19. The warning notification system according to claim 15, wherein
the notification-determination-condition storage unit stores the notification-determination-condition including merely one of the condition for determining depending on the situation of the road whether or not to issue the warning, the condition for determining depending on the state of the vehicle whether or not to issue the warning, and the condition for determining depending on the state of the weather whether or not to issue the warning.

20. The warning notification system according to claim 15, wherein
the route acquisition unit, the event acquisition unit, the situation acquisition unit, the notification-determination-condition storage unit, and the determination unit are provided in a server apparatus capable of communicating with an on-vehicle apparatus mounted on the vehicle.

21. The warning notification system according to claim 15, wherein
the route acquisition unit, the event acquisition unit, the situation acquisition unit, the notification-determination-condition storage unit, and the determination unit are provided in an on-vehicle apparatus mounted on the vehicle.

22. The warning notification system according to claim 15, wherein
the route acquisition unit is provided in an on-vehicle apparatus mounted on the vehicle, the event acquisition unit, the situation acquisition unit, the notification-determination-condition storage unit, and the determination unit are provided in a server apparatus capable of communicating with the on-vehicle apparatus.

23. The warning notification system according to claim 15, wherein
the route acquisition unit, the event acquisition unit, the situation acquisition unit, the notification-determination-condition storage unit, and the determination unit are provided in a portable terminal apparatus carried by a user.

24. The warning notification system according to claim 15, wherein
the route acquisition unit, the notification-determination-condition storage unit, and the determination unit are provided in a portable terminal apparatus carried by a user, and the event acquisition unit and the situation acquisition unit are provided in a server apparatus capable of communicating with the portable terminal apparatus.

25. A waning notification method of a warning notification system comprising:
by a route acquisition unit, acquiring moving route information indicating a moving route of a vehicle;
by an event acquisition unit, acquiring event information representing an event associated with the moving route information acquired by the route acquisition unit;
by a situation acquisition unit, acquiring situation information representing a travelling situation of the vehicle;
by a notification-determination-condition storage unit, storing a condition for determining whether or not to issue a warning with respect to the event information acquired by the event acquisition unit in each case of a plurality of travelling situations, as a notification-determination-condition;
by a notification-determination-condition storage unit, adding priority information representing priority of each of a plurality of notification-determination-conditions to the plurality of the notification-determination-conditions, and storing the plurality of notification-determination-conditions; and
by a determination unit, selecting at least one notification-determination-condition from the plurality of notification-determination-conditions, based on the priority information added to each of the plurality of notification-determination-conditions, and determining whether or not to issue the warning, based on the selected at least one notification-determination-condition and the situation information acquired by the situation acquisition unit.

26. A non-transitory computer readable medium storing a program to cause a computer to execute:
route acquisition processing to acquire moving route information indicating a moving route of a vehicle;
event acquisition processing to acquire event information representing an event associated with the moving route information acquired by the route acquisition processing;
situation acquisition processing to acquire situation information representing a travelling situation of the vehicle;
storage processing to store a condition for determining whether or not to issue a warning with respect to the event information acquired by the event acquisition processing in each case of a plurality of travelling situations, as a notification-determination-condition, to add priority information representing priority of each of a plurality of notification-determination-conditions to the plurality of the notification-determination-conditions, and to store the plurality of notification-determination-conditions; and
determination processing to select at least one notification-determination-condition from the plurality of notification-determination-conditions, based on the priority information added to each of the plurality of notification-determination-conditions, and to determine whether or not to issue the warning, based on the selected at least one notification-determination-condition and the situation information acquired by the situation acquisition processing.
